(19) United States
(12) Patent Application Publication
(10) Pub. No.: US 2018/0115418 A1
(43) Pub. Date: Apr. 26, 2018

(54) Secure Messaging Session

(71) Applicant: Microsoft Technology Licensing, LLC, Redmond, WA (US)

(72) Inventor: Derek Lakin, Lincolnshire (GB)

(73) Assignee: Microsoft Technology Licensing, LLC, Redmond, WA (US)

(21) Appl. No.: 15/401,811

(22) Filed: Jan. 9, 2017

(30) Foreign Application Priority Data
Oct. 20, 2016 (GB) 1617744.6

(51) Int. Cl. H04L 9/08; H04W 12/06; H04W 4/12; H04W 4/02; H04L 9/14; H04L 29/06; H04W 12/04; H04L 9/32

(52) U.S. Cl. CPC H04L 9/0863; H04W 12/06; H04W 4/12; H04W 4/023; H04L 9/14; H04L 2209/80; H04W 12/04; H04L 63/0428; H04L 63/083; H04L 9/3231; H04L 63/06

(57) ABSTRACT

A user device comprises a user interface, a wireless transceiver having a local wireless communication range, computer storage and a processor. The computer storage is configured to store a messaging application for effecting a secure messaging session via a network between the user device and at least one remote device. The messaging application comprises a locking component for locking the secure messaging session. The processor is configured to execute the messaging application. The locking component of the messaging application is configured to determine in response to an unlock input received via the user interface whether a trusted device is present within the local wireless communication range, and to unlock the secure messaging session in dependence thereon.

### RELATED APPLICATIONS

This application claims priority under 35 U.S.C. 119 or 365 to Great Britain Application No. 1617744.6 filed Oct. 20, 2016, the disclosure of which is hereby incorporated by reference in its entirety.

### TECHNICAL FIELD

The present invention relates to a messaging application for effecting a secure messaging sessions, i.e. a messaging session that is selectively locked by a locking component of the messaging application.

### BACKGROUND

Messaging applications (apps) allow users to exchange messages, sometimes referred to as ‘instant messages’, with each other via a network. The network may be a packet-based network such as the Internet. The messages comprise text, i.e. character strings, inputted by each user at his user devices. The messages may also comprise rich content, such as audio or image data (both static and video images). In this manner, the users can engage in a messaging session effected by the messaging application. Each user executes on a processor of his user device an instance of the messaging application to allow the messages to be transmitted and received via the network. The communication may be real time in the sense that there is only a short delay, for example two seconds or less, between one user sending a message and the other user or users receiving it. The messaging application may also have additional functionality, for example, VoIP functionality allowing the users to also place voice or video VoIP calls to one another.

The user device can, for example, be a mobile device such as a smartphone or tablet. Alternatively, it could be another form of computer device such as a laptop or desktop computer, or smart television.

The messaging application may store a local message history at the user device itself. The local message history comprises content exchanged during the messaging session, for example, a selection of the most recently transmitted and received messages. Storing the message history locally at the device in this way permits faster access, rendering the messaging application more responsive to the user as he navigates his messaging history.

### SUMMARY

A first aspect of the present invention is directed to a user device comprising a user interface, a wireless transceiver having a local wireless communication range, computer storage and a processor. The computer storage is configured to store a messaging application for effecting a secure messaging session via a network between the user device and at least one remote device. The messaging application comprises a locking component for locking the secure messaging session. The processor is configured to execute the messaging application. The locking component of the messaging application is configured to determine in response to an unlock input received via the user interface whether a trusted device is present within the local wireless communication range, and to unlock the secure messaging session in dependence thereon.

The local wireless communication range corresponds to a local region of space around the user device in which direct wireless (e.g. RF) communication between the user device and the trusted device via the wireless transceiver is possible. The extent of the wireless communication range is determined by the transmit and receive powers of the wireless transceiver and of the trusted device, as well as the wireless communication technology used by the devices to communicate. For example, Bluetooth typically has a wireless communication range of between about 0.5 m and about 100 m depending on the respective powers of the devices as denoted by their Bluetooth class. Of course, this is subject to variation due to wireless conditions such as noise and interference which may act to reduce the extent of the wireless communication range. In any event, the wireless communication range is such that the trusted device is within it, and is thus detectable and identifiable to the user device via the wireless interface, when the trusted device is in the vicinity of the user device.

Note that the role of the trusted device in the present invention is one of indicating the presence of an authorised user in the vicinity of the user device. In the simplest case, the presence of the trusted device can simply be taken as an indication that a user of the user device is authorised to access the secure messaging session. That is, the locking component of the messaging application may unlock the secure messaging session in response to determining that a trusted device is present within the wireless communication range unconditionally (in so far at the detected presence of the device that is trusted unlocks the session).

Preferably, however, initial steps are taken to authorise the user to the trusted device, such as the user entering a correct passcode at the trusted device. More preferably, the trusted device is a wearable device, wherein once the user has authenticated himself to the wearable device he remains authenticated for as long as the wearable device senses that it is still being worn by the user; this trust relationship between the user and the wearable device terminates when the wearable device detects that it is no longer being worn by the user, such that the detection of the trusted device no longer unlocks the messaging session until the user re-authenticates himself to it. That is, more generally, the locking component may unlock the secure messaging session when it determines that a trusted device is present within the local wireless communication range only if it also determines that a user is currently authenticated to the trusted device.

By contrast, the remote device can be well outside of the wireless communication range, for example, the network may be the Internet and the user device and the remote device can engage in the messaging session over the Internet over very long distances.

In embodiments, the messaging application may be configured when executed on the processor to perform the following messaging operations only when the secure messaging session is unlocked: outputting, via the user interface, messages of the secure messaging session which have been received via the network from the remote device, and transmitting, via the network to the remote device, outgoing messages of the secure messaging session, the outgoing messages generated according to message generation inputs received via the user interface; whereby the unlocking of the secure messaging session by the locking component of the messaging application allows the performance of said messaging operations.

The messaging application may be configured to store a local message history of the secure messaging session in the computer storage as encrypted data, and unlocking the secure messaging session may comprise decrypting at least part of the local message history for outputting via the user interface.

The local message history may be decrypted using key data that is received from the trusted device within the local wireless communication range.

Alternatively or in addition, the local message history may be decrypted using key data held locally at the user device in a secure portion of the computer storage.

For example, the local message history may be encrypted using first key data, wherein the first key data comprises or is derivable from the key data.

As another example, the local message history may be encrypted using second key data, and a version of the second key data encrypted using first key data is stored locally in the computer storage, wherein the first key data comprises or is derivable from the key data.

The key data may be derived from an identifier of the trusted device and/or a passcode (e.g. a pin or passcode) and/or a biometric (e.g. finger print).

The messaging application may be configured to store temporary key data for decrypting the local message history in the computer storage, and the locking component of the messaging application may be configured to lock the secure communication session by erasing the temporary key data from the computer storage.

For example, the temporary key data may be stored in, and erased from, a volatile memory region of the computer storage.

The locking component of the messaging application may be configured to unlock the secure messaging session in response to determining that a trusted wireless device is within the wireless communication range only if it determines that a user is currently authenticated to that device.

The messaging application may be for effecting both secure and unsecure messaging sessions (i.e. having a secure or unsecure type), wherein the unsecure messaging sessions remain unlocked when no trusted device is determined to be within the wireless communication range.

The messaging application may be configured to set a type of a messaging session as secure or unsecure according to user inputs received at the user interface.

The processor may be configured to detect the trusted device within the local wireless communication range and authenticate it using trusted device data stored locally in the computer storage.

For example, the trusted device data may be a shared secret previously agreed with the trusted device.

The computer storage may be configured to store an operating system for execution on the processor, and the locking component may be configured to run on top of the operating system as part of the messaging application when executed, wherein the messaging application and its locking component are not part of the operating system.

A second aspect of the present invention is directed to a system comprising the user device and the trusted device of the first aspect or any embodiment thereof.

The trusted device may be a wearable device.

As noted, the local message history may be decrypted using key data that is received from the trusted wearable device within the local wireless communication range. That is, key data received from at the wearable device may be needed to decrypt the history. In this case, the wearable device may be configured to erase the key data if it detects a removal of the wearable device from a user.

A third aspect of the present invention is directed to a method of effecting a secure messaging session between a user device and at least one remote device via a network, the method comprising, at the user device: receiving via a user interface of the user device at a messaging application executed on a processor of the user device an unlock input pertaining to the secure messaging session; wherein a locking component of the messaging application determines in response to the unlock input whether a trusted device is present within a local wireless communication range of the user device, and unlocks the secure messaging session in dependence thereon.

In embodiments of the third aspect, any feature of the first or second aspect or any embodiment thereof may be implemented.

In embodiments, the messaging application may store a local message history of the secure messaging session at the user device as encrypted data, and unlocking the secure messaging session may comprise decrypting the local message history for outputting via the user interface.

Alternatively or in addition, the messaging application may perform the following messages operations only when the secure messaging session is unlocked: outputting, via the user interface, messages of the secure messaging session which have been received via a network from the remote device, and transmitting, via the network to the remote device, outgoing messages of the secure messaging session, the outgoing messages generated according to message generation inputs received via the user interface.

A fourth aspect of the present invention is directed to a computer program product comprising a messaging application stored on a computer readable storage medium and configured when executed to implement the method of the second aspect or any embodiment thereof.

### BRIEF DESCRIPTION OF FIGURES

For a better understanding of the present invention and to show how embodiments of the same may be carried into effect, reference is made to the following figures, in which:

FIG. 1 shows a schematic block diagram of a communication system;

FIG. 2 shows a schematic block diagram of a user device communicating wirelessly with a trusted device;

FIG. 3 shows a flowchart for a method of managing a secure messaging session which is implemented by a messaging application executed on a processor of a user device;

FIG. 4a illustrates one example means by which a local message history of a secure communication system may be encrypted at a user device;

FIG. 4b shows another example means by which a local message history may be encrypted at a user device;

FIG. 5a schematically illustrates key data for use in encrypting a local message history;

FIG. 5b schematically illustrates how such key data may be generated;

FIGS. 6a and 6b show different examples of encryption hierarchies that may be implemented at a user device; and

FIGS. 7a and 7b show example user interfaces displayed at a user device by a messaging application.

### DETAILED DESCRIPTION OF EXAMPLE EMBODIMENTS

Sometimes the information exchanged in a messaging session may be of a sensitive nature. For example, it may include personal or confidential information that the users would not wish to be disseminated without their approval. Existing user devices do offer some form of protection in that they include general locking functionality to selectively lock the whole device. When the device is locked in this manner it is unusable (or only usable to a very limited extent) until the user takes positive action to unlock it, for example, by entering a passcode or scanning his fingerprint where the device includes this functionality. However, users often find the consequent restrictions irritating, and may therefore choose not to enable such functionality. Often this choice is made by the user without fully considering the consequences of it. That is, users often do not appreciate the implications of disabling device locking in terms of their personal data until after the device has been lost or stolen when it is often too late to do anything about it. In particular, a user who disables the device-wide locking functionality will often not appreciate the implications of this in terms of his message history and the fact that a nefarious user acquiring his device will be able to see his message history and any sensitive information he has exchange during messaging sessions. This can, for example, be easily accessed where the chat history is stored locally on the user device or where authentication data is stored on the user device that allows it to retrieve the messaging history from a server without additional authentication (that is, where the user is still logged in at the messaging app).

Existing user devices do go some way towards solving this problem by simplifying the unlocking procedure. In particular, recently smartphones have been equipped with the functionality wherein the smartphone unlocks itself automatically if it detects in its vicinity a trusted wearable device being worn by a user. However, there is still a problem with this approach in that it only provides device-wide locking. As noted, users are prone to disabling or choosing not set up device-wide locking systems because they fail to appreciate the consequences of this in terms of the data maintained by individual applications, and messaging applications in particular.

The present invention solves this problem by providing a messaging application which comprises a locking component for locking individual messaging sessions. Messaging sessions that are lockable in this way are referred to as secure messaging sessions herein. Implementing locking functionality as part of the messaging application itself, where the locking functionality is local to and contained within the messaging application rather than being device-wide, significantly reduces the risk of users choosing to disable or not make use of this locking functionality without fully appreciating the consequences in terms of their sensitive messaging data. Preferably, the messaging application provides both secure and non-secure messaging sessions, where the user can choose between the two, depending on the nature of the messaging session in question.

In order to implement this internal messaging application locking functionality with minimum burden placed on the user, the locking component of the messaging application is configured to unlock a secure messaging session if it determines that a trusted device, preferably a wearable device worn by the user, is present within a local wireless communication range of the user device. That is, a device that is trusted by the user device and located sufficiently near to the user device that it is detectable and identifiable based on short-range direct wireless communication between the user device and the trusted device, such as Bluetooth.

In the examples described below, a user device runs a messaging application (chat client). The chat client provides both secure and unsecure messaging sessions (chats) wherein the unsecure chat is always visible/accessible to a user of the device and the secure chat must be unlocked before it is viewable/accessible to a user. The device wireless has (e.g. Bluetooth) connectivity and the user selects one or more connected Bluetooth devices (a trusted device). When the user attempts to access a secure chat, the chat is unlocked and accessible if any of the trusted Bluetooth devices are detected.

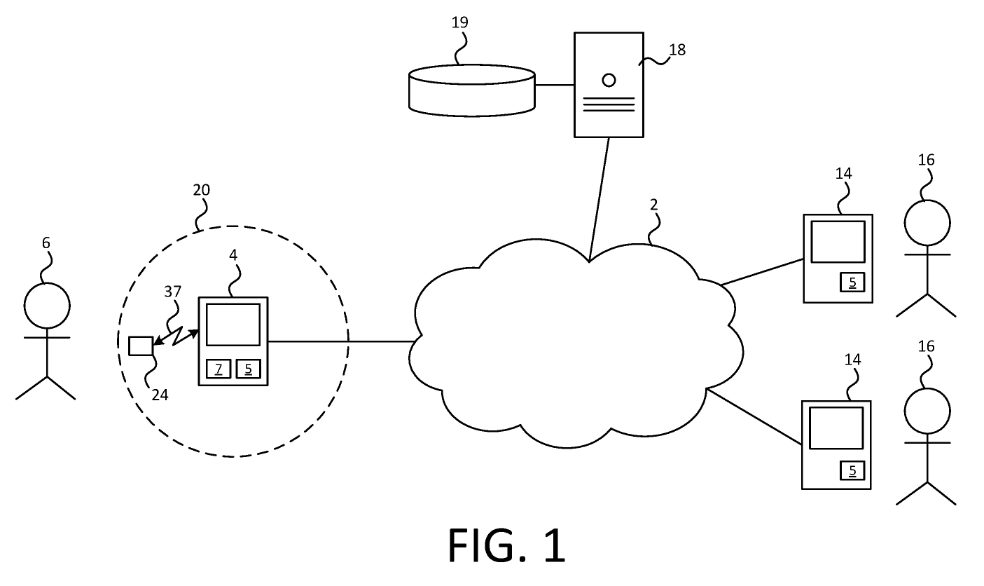

FIG. 1 shows a communication system comprising a network 2 and, connected to the network 2: a user device 4, one or more one or more remote user devices 14 (remote from the user device 4), each operated by a remote user 16, and a messaging server 18.

A user 6 (local user) is shown operating the user device 4 and another device 24 in the vicinity of the user device 4. The other device 24 is a wearable device, such as a smartwatch, headset, clip-on device for attaching to a garment, etc. though this is not shown explicitly in FIG. 1. The wearable device 24 is in the vicinity of the user device 4 in that it is located within a local wireless communication range 20 of the user device 4 such that a wireless communication channel 37 can be established between the wearable device 24 and the user device 4.

The network 2 is a packet-based computer network such as the Internet. Each of the user devices 4, 14 is shown to be executing a respective instance of a messaging application 5 (chat client or chat app). The messaging application 5 allows the users 6, 16 to transmit and receive messages, referred to as instant messages, to each other via the network 2 in a messaging session conducted between the users 6, 16 (chat). The content of these message is primarily text-based though they may also include rich content such as audio or image data. The messages may, for example, be relayed via the messaging server 18 and the messaging server 18 may store a record of the exchanged messages in a remote database 19. In this manner, a remote message history for the communication session is maintained in the remote database 19 which can, for example, be rendered accessible to the users 6, 16 using their devices 4, 14, or other devices subject to any required user and/or device authentication.

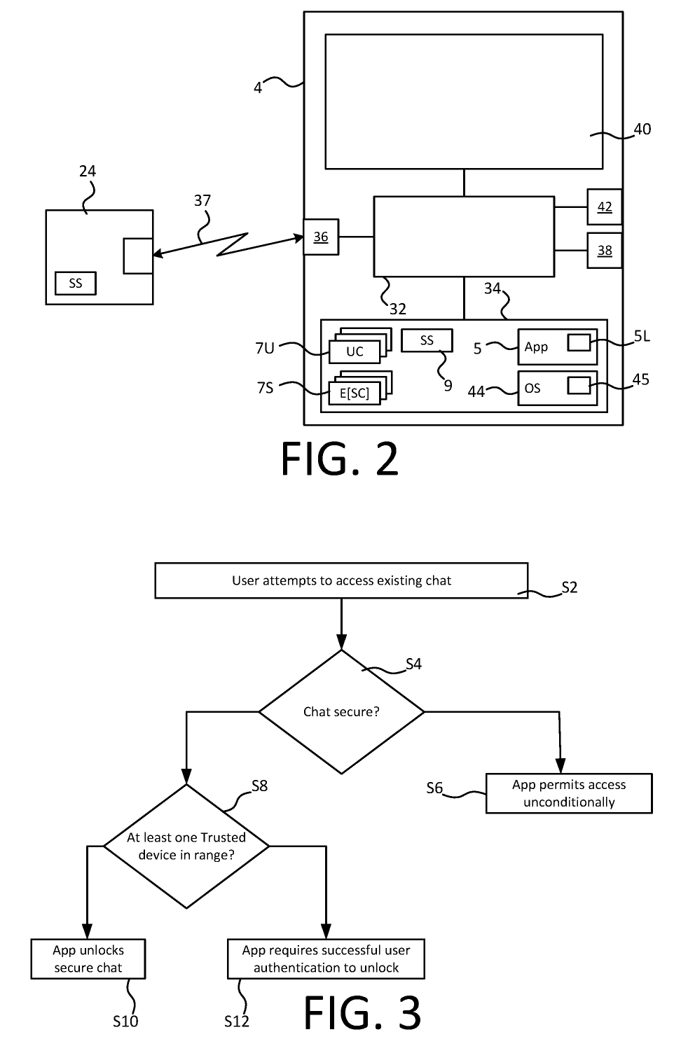

In addition, the messaging application 5 stores at the user device 4 a local message history 7 which comprises at least part of the content exchanged in the messaging session, for example, the most recently transmitted and received messages. In the examples described herein, the messaging application 5 selectively encrypts the local message history 7 depending on a type of each of the messaging sessions, and in particular whether the user has set the type of the messaging session as secure. The user 6 can choose to set the type of each messaging session as secure or unsecure, and may be able to change the type of an existing messaging session in some implementations. As explained in detail below, the messaging application 5 will only permit access to the encrypted parts of local message history 7 under certain circumstances. For now, suffice it to say that one way of unlocking the communication session to gain access to an encrypted local message history (7U, FIG. 2) is to bring the wearable device 24 into the local wireless communication range 20 such that it can be detected and authenticated by the user device 4. As noted already, this may also be conditional on the user 6 being authenticated to the wearable device 24.

Note the terms “messaging session”, “communication session”, and “messaging communication session” are used interchangeably herein.

FIG. 2 shows a highly schematic block diagram of the user device 4 in communication with the wearable device 24. The user device 4 is shown to comprise a processor 32 to which the following components are connected: computer storage 34, a wireless transceiver 36, a network interface 38, a display 40 and at least one user input device 42 such as a touchscreen, mouse or trackpad. The display 40 and at least one user input device 42 constitute a user interface of the user device 4. This is just one example of a suitable user interface, and other user devices may comprise other forms of user interface, for example, based on speech recognition, gesture recognition, intent recognition or other forms of so-called “natural” user interface engagement. The processor 32 may, for example, comprise a CPU or CPUs. The computer storage 34 is shown to be holding the messaging application 5 and an operating system (OS) 44 for execution on the processor 32. As is known in the art, the operating system 44 when executed on the processor 32 supports the user device's basic functions, such as software scheduling and management of peripherals like the display 40 and wireless transceiver 36, etc. The operating system 44 is shown to comprise a wireless communication management component 45, which when executed as part of the operating system 44 cooperates with the wireless transceiver 36 in order to provide wireless communication functionality to applications running on top of the OS 44, such as the messaging application 5. For example, preferably the wireless transceiver 36 and wireless communication management component 45 are implemented based on Bluetooth technology so as to allow Bluetooth communication to take place via the wireless transceiver 36. The messaging app 5, when executed on the processor 32 runs on top of the OS 44. The messaging application 5 is shown to comprise a locking component 5L which, when executed on the processor 32 as part of the messaging application 5 implements functionality to allow selective locking of secure messaging sessions, including the encryption functions described briefly above. This locking functionality is thus incorporated in the messaging application itself, and is not part of the OS 44. That is, this locking functionality is restricted to and contained within the messaging app 5 separately and independently from any device-wide locking functionality that might or might not be implemented by the OS 44, and thus independently of whether or not such device-wide locking functionality is or is not enabled by the user 6.

Also shown stored in the computer storage 34 are a plurality of unsecured chat histories 7U, each being a chat history of a different unsecure messaging session (UC), and a plurality of secure local message histories 7S, each being a local message history of a secure messaging session that is stored as encrypted data (denoted E[SC]). Access to these secure encrypted message histories 7S is only selectively permitted by the locking component 5L of the messaging app 5.

In addition, the computer storage 34 holds a shared secret 9 (SS), a version of which is also shown to be stored at the wearable device 24. The shared secret 9 is a piece of information that is known only to the user device 4 and the wearable device 24, and which is held at those devices in a secure fashion. The shared secret 9 can be agreed between the user device 4 and the wearable device 24 as part of a pairing procedure, such as a Bluetooth pairing. Versions of the Bluetooth protocol use a Diffie-Hellman Key Exchange in order to securely agree the shared secret over an unsecured wireless communication channel established by the wireless transceiver 36. Such protocols are known in the art and further details of the pairing will not be described herein.

If and when the wearable device 24 is detected within the local wireless communication range 20 of the user device 4, the user device can instigate a so-called challenge procedure, in which it issues a challenge to the wearable device 24 via the wireless transceiver 36. The challenge is based on the shared secret 9 and is such that the wearable device 24 can only respond to the challenge correctly if it also has knowledge of the shared secret 9. The shared secret 9 remains secret throughout. The user device 4 is thus able to authenticate the wearable device 24 based on this challenge and its response. During this process the shared secret 9 is not released by the devices but the challenge and response process is such that the user device 4 knows that the wearable device 24 must also have access to the shared secret 9 if it responds correctly. In this sense, the wearable device 24 is a trusted device from the perspective of the user device 4 where that trust relationship is established by the mutual knowledge of the shared secret 9. Such challenge response paradigms based on a shared secret are known in the art, and are for example incorporated in the Bluetooth protocol, therefore further details will not be discussed herein.

In the present examples the pairing procedure to establish the shared secret 9 and the subsequent detection and authentication of the wearable device via the wireless transceiver 36 is managed by the wireless communication management component 45 of the operating system 44. That is, it is included as part of the user device's native OS functionality. Alternatively, this functionality can be implemented by code outside of the operating system 44, for example, that is provided as part of an installable driver for the wireless transceiver 36, which can be a modular component such as a USB peripheral.

FIG. 3 shows a flow chart for a method of managing messaging sessions, which is implemented by the messaging app 5 when executed on the processor 32.

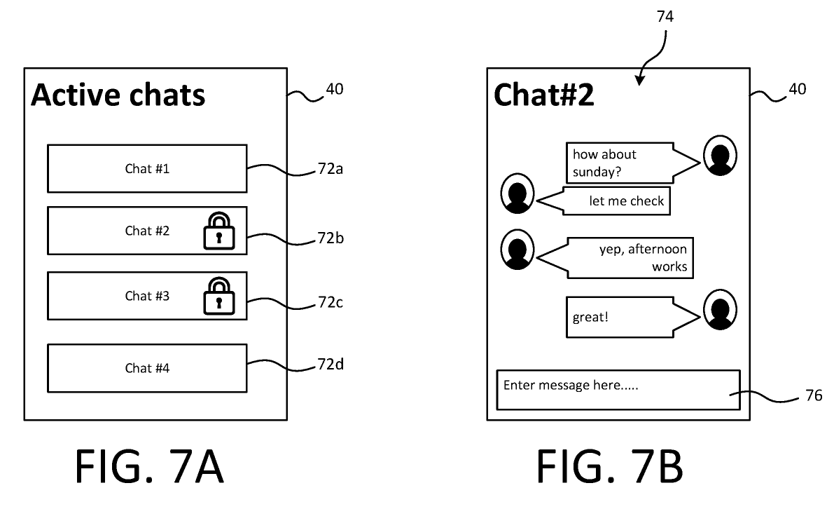

At step S2, the user 6 attempts to access using the user input device 42 an existing messaging session. That is, a messaging session for which a local message history 7U, 7S is already stored in the computer storage 34. FIG. 7a shows a highly simplified example of a chat selection display screen that may be displayed by the messaging app 5 on the display 40 to allow the user 6 to select from existing messaging sessions. Each of a plurality of existing messaging sessions is represented by a respective selectable UI element 72a, 72b, 72c and 72d, which the user can select in order to access that messaging session and in particular the local message history for that messaging section subject to certain constraints. In this way, the user 6 provides an unlock input via the user interface upon selecting a locked session. At step S4, the method branches depending on whether or not the selected chat is a secure chat. If not, the messaging app 5 provides access to the locally stored message history 7U for that chat unconditionally. In this example, the messaging app 5 does not take any steps to encrypt the unsecure message history 7U and it is unencrypted in this sense (though the possibility of some encryption that is applied and managed independently of the messaging app 5, for example, by the OS 44, is not excluded. However, the assumption here is that this cannot be relied upon to secure the local message histories managed by the messaging app 5). This is denoted step S6 in FIG. 3.

On the other hand, if the selected chat is secured, access to the local message history 7S is only granted by the messaging app 5 under certain circumstances (step S8). That is, the secure chat is only unlocked by the locking component 5L of the message app 5 conditionally. One of the conditions under which the locking component 5L of the messaging app 5 will unlock the chat is when the trusted wearable device 24 is within the wireless communication range 20 of the user device 4 (step S10). In that event, the locking component 5L will allow access to the selected secure messaging session and in particular to the encrypted local message history 7S, without requiring any additional or authentication such as the entering of a passcode, a fingerprint scan, etc. That is, the locking component 5L will permit access to the encrypted history 7S based solely on the authentication, and resulting trust relationship, between the user device 4 and the trusted wearable device 24, which, as noted above, ultimately stems from the mutual knowledge of the shared secret 9. As also noted, this may also require the user 6 to be authenticated to the wearable device 24 in range. As described further in detail below, this can for example require the user 6 to provide user authentication information to the wearable device 24 when wearing it, such as a passcode or biometric (e.g. fingerprint, iris scan, etc.), to initially authenticate himself He may then remain authenticated until he removes the device 24 or some other termination event occurs.

If the trusted wearable device 24 is not within the wireless communication range 20 and no other trusted device is within the wireless communication range 20, then in order to unlock the secure messaging session, the locking component 5L of the messaging app 5 requires some other form of authentication, for example, it may require the user to enter a passcode (e.g. password, PIN, etc.) before it will unlock the messaging session and allow access to the encrypted local message history 7S (step S12). Alternatively, as in addition, the user 6 may be required to provide a biometric to the loading component SL in that event. Thus, in that event, it may still be possible for the user 6 to gain access to the secure messaging session but only if they can successfully complete a suitable authentication process with the locking component 5L of the messaging app 5

In FIG. 7a, chats 1 and 4 are unsecure and are selectable via UI elements 72a and 72d respectively. On the other hand, chats 2 and 3 are secured chats, which are subject to a successful unlock accessible via user interface element 72b and 72c. In this example, these are marked as secured by icons displayed in association with UI elements 72b and 72c.

FIG. 7b shows an example of a chat display screen for chat 2, to demonstrate what might be displayed to a user upon a successful unlocking of that chat. The local message history for that chat is displayed as a sequence of displayed messages 74 between the user 6 and at least one remote user 16 who is also a participant in the secure messaging session. The messages are displayed in the manner of a conventional instant messaging application, and further details of the display mechanism will not be described herein. The user can also enter messages to be sent to the at least one of the user 16 via UI element 76, thereby allowing the secure messaging session to continue from the end of the displayed history 74.

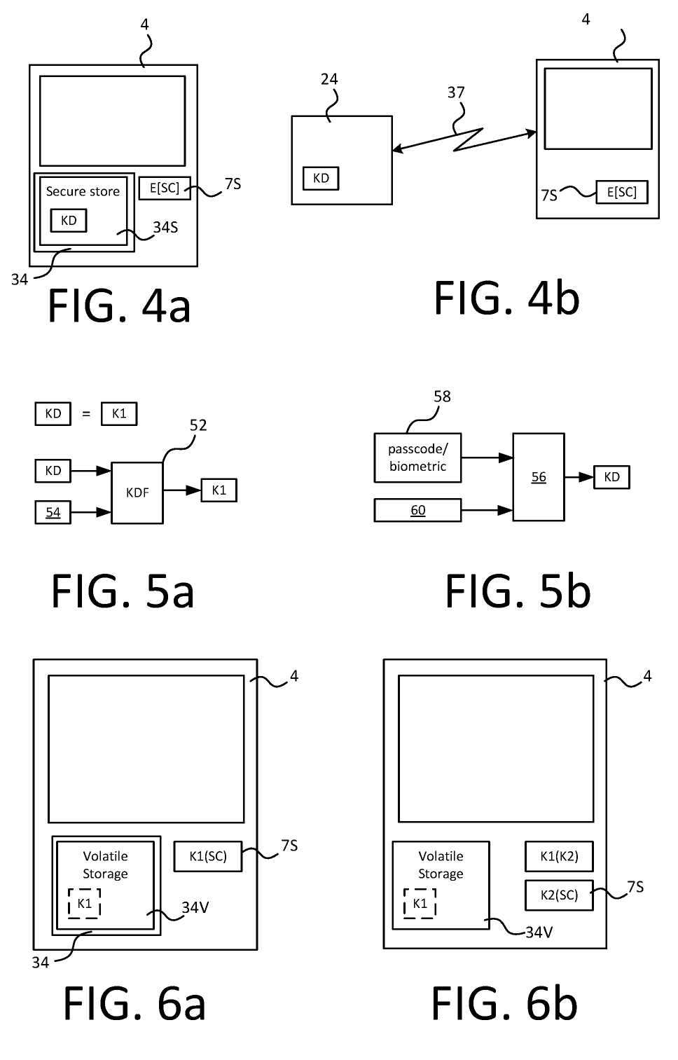

To aid illustration, various examples of encryption mechanisms that can be used to secure the local message history 7S for secure messaging sessions will now be described with reference to FIGS. 4a through 6b.

FIGS. 4a and 4b illustrate two general, alternative mechanisms by which key data KD for decrypting the encrypted message history 7S can be stored. In the first example of FIG. 4a, the key data KD is stored at the user device 4 itself in a special secure region 34S of the computer storage 34. For example, in a dedicated key store provided as part of the architecture of the user device 4 itself. It is known for a device, such as a smartphone, to include a special, secure region of storage, separated from the main storage and usually limited in size. The manner in which this region is secured differs from device to device, but is such that it is significantly harder to retrieve information from it without authentication.

In the second example of FIG. 4b, the key data KD is instead stored at the trusted device 24. This key data KD is communicated from the secure device 24 to the user device 4 in order to unlock the secure messaging session via the wireless communication channel 37 (or by some other communication means). That is to say, at least some of the data needed in order to decrypt the secure message history 7S is only kept at the trusted device 24. This is more secure, because the fact that the key data KD is held only at the trusted device 24 means that there is insufficient information held at the user device 4 itself to be able to decrypt the secure message history 7S.

As illustrated in FIG. 5a, the key data can be an encryption key denoted K1 or it can be data that can be used to derive the encryption key K1 using a key derivation function 52 that is implemented by the locking component 5L (for example). For the latter, the key data KD is an input to the key derivation function 52 and the key derivation function 52 may also receive one or more other pieces of data as inputs which it uses in addition to the key data KD in generating the encryption key K1.

As shown in FIG. 5b, the key data KD can, for example, be generated by applying a function to a piece of secret data known only to the user 6 such as a passcode 58. The function is denoted 56 in FIG. 5b and receives the passcode 58 as an input. It may also receive one or more other pieces of data 60 as inputs which it uses in addition to the passcode to generate the key data KD.

For example, another input to enter functions 52, 56 could be an identifier (ID) unique to the trusted device 24, such as a MAC address, to provide increased entropy.

As shown in FIG. 6a, the encryption key K1 can be used to encrypt the message history 7S directly—denoted K1(SC). However, preferably, as shown in FIG. 6b, a second encryption key K2 is used to encrypt the message history 7S—denoted K2(SC)—and an encrypted version of key K2 is also stored at the user device in the computer storage 34 which is encrypted using key K1—denoted K1(K2). This is preferred as it provides greater flexibility. For example, other versions of the key K2 can be stored at the user device encrypted in a different manner, for example, based on a passcode or fingerprint such that key K2 can still be accessed to decrypt the message history 7S even when the key K1 is not available. As shown in FIGS. 6a and 6b, the key K1 (or data for deriving the key K1) may be temporarily stored at the user device 4, for example in a volatile memory region 34V of the computer storage 34 only while the messaging session is unlocked. The locking module 5L can quickly lock the messaging session reliably by simply erasing the temporary version of the key K1 from the volatile memory 34V. As is known in the art, the volatile memory refers to memory in which data persists only while that memory is powered. An example of volatile memory is random access memory. Once data has been erased from volatile memory, it is virtually impossible to recover which provides a very high level of security. Whilst the temporary version key is held in the volatile storage 34V on the other hand, the locking module 5L of the messaging app 5 can use this version of the key in order to quickly and efficiently access the secure message history 7S. Volatile memory 34V is useful in this context, as it is something an application is guaranteed to have access to on any device (whereas the secure store 34S may not be available on all devices, and on some devices, even if available, it may only be accessible to, say, the OS 44 and not third party apps running on it).

In the scenario of FIG. 4a, where the key K1 and/or the key data KD (if those are different) is derived from user information, such as a passcode or biometric, once the temporary version of the key K1 is erased from volatile storage, it cannot be restored until this user information is provided to the user device 4.

In the scenario of FIG. 4b, in which the key data KD is provided by the wearable device 24, once the temporary version of the key K1 has been erased from the volatile stored 34V, the only way to get back the key K1 at the user device 4 is to receive it from the wearable device 24, which in turn is only possible if the wearable device 24 is within range 20 of the user device 4.

Preferably, in this scenario of FIG. 4b, the wearable device 24 only retains the key data KD under certain circumstances. For example, when the wearable device 24 detects that it has been removed from the user, i.e. that it is no longer being worn by the user, it may wipe the key data KD. For example, the wearable device 24 may retain the key data KD only in volatile memory, such that it can easily erase it when it detects that it is no longer being worn. In order to recover the key data at the wearable device 24, the user 6 has to put the wearable device back on and authenticate himself to the wearable device 24 for example, by entering a passcode or fingerprint. That is, more generally, the key data KD is only held at the wearable device 24 for as long as the user 6 remains authenticated to the wearable device 24. With reference to FIG. 5b, successful recognition of the fingerprint or passcode allows the function 56, which in this example is implemented at the wearable device 24, to recover the key data KD. The fresh key data KD may be retained at the wearable device 24 for as long as it is being worn by the user, such that it can be transmitted via the wireless communication channel 37 to the user device 4 when in range 20 of the user device 4 for use in decrypting the secure message history 7S.

Note that whilst the above has described an example of locking in relation to local message histories, the present invention is not limited to this type of locking. For example, a secure messaging session can be said to be locked when the locking component of the messaging application blocks access to a messaging function of the messaging application in relation to the secure communication session when locked. That is, such that the user is unable to see messages of the locked communication session which have been received from the remote user(s) 16, and the user 6 is prevented from transmitting new, outgoing messages of the locked messaging session to the remote user(s) 16. In this case, unlocking of the secure messaging session by the locking component 5L of the messaging application 5 grants access to the messaging function for the unlocked session, thereby allowing the performance of those messaging operations. As another example, alternatively or in addition, a messaging session can be unlocked by providing access to the remotely stored message history in the remote database 19 for a secure messaging session only when that messaging session is unlocked, for example by rendering successful authentication of the user device 6 with the messaging server 18 conditional on at least one trusted device 24 being within the wireless communication range 20.

Note that the term “processor” is used to refer to an apparatus, comprising one or more processing units (such as CPUs), that is capable of executing code, i.e. executable instructions, i.e. software, such as the messaging application 5 and OS 44. In the case of multiple processing units, these can be on the same or different chips, dies etc. The term “computer storage” is used to refer generally to one or more computer readable storage devices, such as magnetic or solid-state storage devices or other forms of electronic storage. In general, the messaging application 5 can be stored one or more computer readable memory devices, including not only electronic storage but also, say, optical storage, such as a disk. The features of the techniques described herein are platform-independent, meaning that the techniques may be implemented on a variety of commercial computing platforms having a variety of processors. The messaging application 5 may be provided via a computer-readable medium to the user device 4 through a variety of different configurations. One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A user device comprising:
a user interface;
a wireless transceiver having a local wireless communication range;
computer storage configured to store a messaging application for effecting a secure messaging session via a network between the user device and at least one remote device, wherein the messaging application comprises a locking component for locking the secure messaging session; and
a processor configured to execute the messaging application;
wherein the locking component of the messaging application is configured to determine in response to an unlock input received via the user interface whether a trusted device is present within the local wireless communication range, and to unlock the secure messaging session in dependence thereon.

2. A user device according to claim 1, wherein the messaging application is configured when executed on the processor to perform the following messaging operations only when the secure messaging session is unlocked:
outputting, via the user interface, messages of the secure messaging session which have been received via the network from the remote device, and
transmitting, via the network to the remote device, outgoing messages of the secure messaging session, the outgoing messages generated according to message generation inputs received via the user interface;
whereby the unlocking of the secure messaging session by the locking component of the messaging application allows the performance of said messaging operations.

3. A user device according to claim 1, wherein the messaging application is configured to store a local message history of the secure messaging session in the computer storage as encrypted data, and unlocking the secure messaging session comprises decrypting at least part of the local message history for outputting via the user interface.

4. A user device according to claim 3, wherein the local message history is decrypted using key data that is received from the trusted device within the local wireless communication range; and/or
wherein the local message history is decrypted using key data held locally at the user device in a secure portion of the computer storage.

5. A user device according to claim 4, wherein the local message history is encrypted using first key data, wherein the first key data comprises or is derivable from the key data.

6. A user device according to claim 4, wherein the local message history is encrypted using second key data, and a version of the second key data encrypted using first key data is stored locally in the computer storage, wherein the first key data comprises or is derivable from the key data.

7. A user device according to claim 3, wherein the key data is derived from an identifier of the trusted device and/or a passcode and/or a biometric.

8. A user device according to claim 3, wherein the messaging application is configured to store temporary key data for decrypting the local message history in the computer storage, and the locking component of the messaging application is configured to lock the secure communication session by erasing the temporary key data from the computer storage.

9. A user device according to claim 8, wherein the temporary key data is stored in, and erased from, a volatile memory region of the computer storage.

10. A user device according to claim 1, wherein the locking component of the messaging application is configured to unlock the secure messaging session in response to determining that a trusted wireless device is within the wireless communication range only if it determines that a user is currently authenticated to that device.

11. A user device according to claim 1, wherein the messaging application is for effecting both secure and unsecure messaging sessions, wherein the unsecure messaging sessions remain unlocked when no trusted device is determined to be within the wireless communication range.

12. A user device according to claim 11, wherein the messaging application is configured to set a type of a messaging session as secure or unsecure according to user inputs received at the user interface.

13. A user device according to claim 1, wherein the processor is configured to detect the trusted device within the local wireless communication range and authenticate it using trusted device data stored locally in the computer storage.

14. A user device according to claim 13, wherein the trusted device data is a shared secret previously agreed with the trusted device.

15. A user device according to claim 1, wherein the computer storage is configured to store an operating system for execution on the processor, and the locking component is configured to run on top of the operating system as part of the messaging application when executed, wherein the messaging application and its locking component are not part of the operating system.

16. A user device according to claim 1, wherein the trusted device is a wearable device.

17. A user device according to claim 1, wherein the trusted device is a wearable device configured to erase the key data if it detects a removal of the wearable device from a user.

18. A method of effecting a secure messaging session between a user device and at least one remote device via a network, the method comprising, at the user device:
receiving via a user interface of the user device at a messaging application executed on a processor of the user device an unlock input pertaining to the secure messaging session;
wherein a locking component of the messaging application determines in response to the unlock input whether a trusted device is present within a local wireless communication range of the user device, and unlocks the secure messaging session in dependence thereon.

19. A method according to claim 18, wherein the trusted device is a wearable device.

20. A computer program product comprising a messaging application stored on a computer readable storage medium and configured when executed on a processor of a user device to effect a secure messaging session between the user device and at least one remote device via a network, by implementing operations comprising:
receiving via a user interface of the user device an unlock input pertaining to the secure messaging session;
wherein a locking component of the messaging application is configured to determine in response to the unlock input whether a trusted device is present within a local wireless communication range of the user device, and unlock the secure messaging session in dependence thereon.
